(19) United States
(12) Patent Application Publication
(10) Pub. No.: US 2025/0392639 A1
(43) Pub. Date: Dec. 25, 2025

(54) DATA MIGRATION TO CLOUD BASED ON LOCAL SPACE

(71) Applicant: International Business Machines Corporation, Armonk, NY (US)

(72) Inventors: Beth Ann Peterson, Tucson, AZ (US); Matthew G. Borlick, Tucson, AZ (US); Lokesh Mohan Gupta, Tucson, AZ (US)

(21) Appl. No.: 18/748,680

(22) Filed: Jun. 20, 2024

(51) Int. Cl. H04L 67/1097

(52) U.S. Cl. CPC H04L 67/1097

(57) ABSTRACT

Migrating data to cloud storage includes identifying, by a storage control unit, data to be migrated to cloud storage. The storage control unit determines unit, that local storage space has reached a threshold. The storage control unit, in response to determining that the local storage space has reached the threshold, migrates data from local storage to cloud storage.

### BACKGROUND

Storage networks, such as storage area networks (SANs), are used to interconnect different types of data storage systems with different types of servers (also referred to herein as “host systems”). Some servers involve various hardware such as data storage media, storage controllers, memories, and the accompanying power systems, cooling systems, etc.

Storage controllers control access to data storage media and memories in response to read and write requests. The storage controllers may direct the data in accordance with data storage devices such as RAID (redundant array of independent disks), JBOD (just a bunch of disks), and other redundancy and security levels. As an example, an IBM® ESS (Enterprise Storage Server) such as a DS8000 series has redundant clusters of computer entities, cache, non-volatile storage, etc.

### SUMMARY

Aspects of the disclosure may include a computer implemented method, computer program product, and system for migrating data to cloud storage. An example method includes identifying, by a storage control unit, data to be migrated to cloud storage. The method further includes determining, by a storage control unit, that local storage space has reached a threshold. The method further includes, in response to determining that the local storage space has reached the threshold, migrating, by the storage control unit, data from local storage to cloud storage.

The above summary is not intended to describe each illustrated embodiment or every implementation of the present disclosure.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a high-level block diagram depicting one embodiment of an example network environment;

FIG. 2 is a high-level block diagram depicting one embodiment of an example storage system.

FIG. 3 is a block diagram of one embodiment of an example device adapter.

FIG. 4 is a flow chart depicting an embodiment of an example method of automatic migration of data to cloud storage.

FIG. 5 is a block diagram of an example computing environment.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

As used herein, the phrases “at least one”, “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. Additionally, the term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably. The term “automatic” and variations thereof, as used herein, refers to any process or operation done without material human input when the process or operation is performed. Human input is deemed to be material if such input directs or controls how or when the process or operation is performed. A process which uses human input is still deemed automatic if the input does not direct or control how or when the process is executed.

The terms “determine”, “calculate” and “compute,” and variations thereof, as used herein, are used interchangeably and include any type of methodology, process, mathematical operation, or technique. Hereinafter, “in communication” or “communicatively coupled” shall mean any electrical connection, whether wireless or wired, that allows two or more systems, components, modules, devices, etc. to exchange data, signals, or other information using any protocol or format. Furthermore, two components that are communicatively coupled need not be directly coupled to one another, but can also be coupled together via other intermediate components or devices.

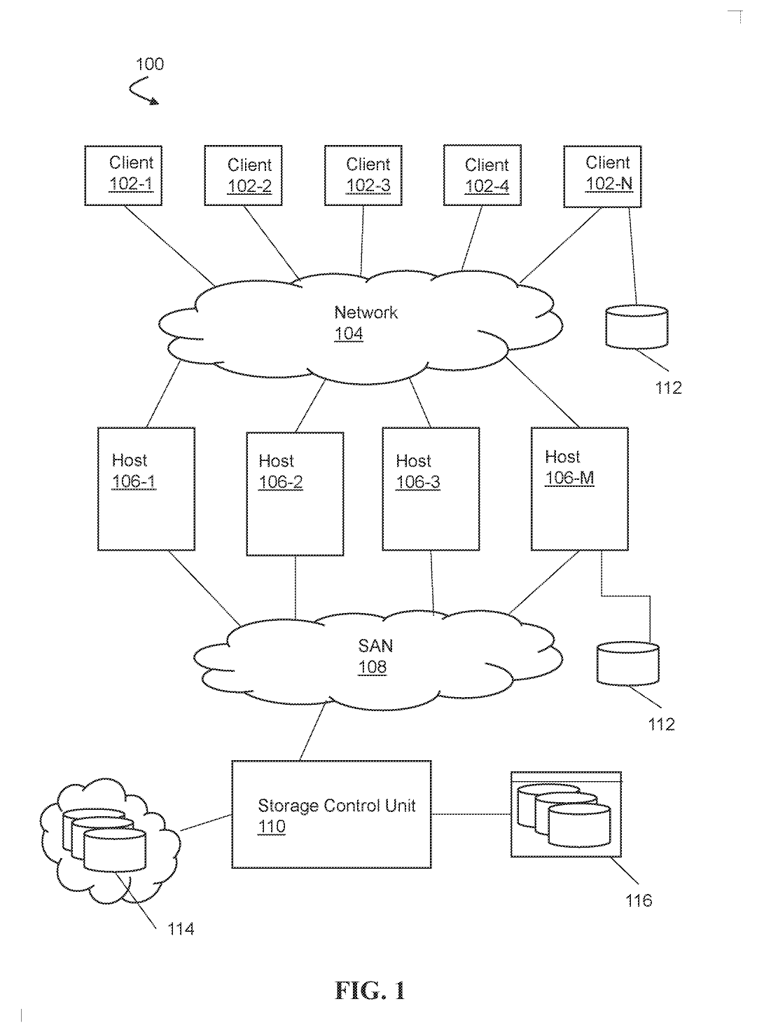

FIG. 1 is a high-level block diagram depicting one embodiment of an example network architecture 100. The network architecture 100 is presented only by way of example and not limitation. Indeed, the systems and methods disclosed herein may be applicable to a wide variety of different network architectures in addition to the network architecture 100 shown in FIG. 1.

As shown, the network architecture 100 includes one or more clients or client computers 102-1…102-N, where N is the total number of client computers, and one or more hosts 106-1 … 106-M, where M is the total number of hosts (also referred to herein as “server computers” 106, “host systems” 106, or “host devices” 106). It is to be understood that although five clients 102 are shown in FIG. 1, other numbers of clients 102 can be used in other embodiments. For example, in some embodiments only one client 102 is implemented. In other embodiments, more than five or fewer than 5 clients 102 are used. Similarly, it is to be understood that although four hosts 106 are shown in FIG. 1, any suitable number of hosts 106 can be used. For example, in some embodiments, only a single host 106 is used. In other embodiments, more than four or fewer than four storage hosts 106 can be used.

Each of the client computers 102 can be implemented as a desktop computer, portable computer, laptop or notebook computer, netbook, tablet computer, pocket computer, smart phone, or any other suitable type of electronic device. Similarly, each of the hosts 106 can be implemented using any suitable host computer or server. Such servers can include, but are not limited to, IBM System z® and IBM System i® servers, as well as UNIX servers, Microsoft Windows servers, and Linux platforms.

The client computers 102 are communicatively coupled to hosts 106 via a network 104. The network 104 may include, for example, a local-area-network (LAN), a wide-area-network (WAN), the Internet, an intranet, or the like. In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network architecture 100 may, in certain embodiments, include a storage network 108 behind the servers 106, such as a storage-area-network (SAN) or a LAN (e.g., when using network-attached storage). In the example shown in FIG. 1, the network 108 connects the servers 106 to one or more storage control units 110. Although only one storage control unit 110 is shown for purposes of illustration, it is to be understood that more than one storage control unit 110 can be used in other embodiments. The storage control unit 110 manages connections to arrays of storage devices 116. The arrays of storage devices 116 can include arrays of hard-disk drives and/or solid-state drives. In addition, in the example shown in FIG. 1, the storage control unit 110 is configured to connect to and create storage arrays from cloud storage 114 such that the cloud storage appears as a local storage array which enables advanced data management features, as described in more detail below.

In addition, in conventional systems cold data (e.g., data which is not accessed frequently) can be placed on relatively slower storage media (e.g., spinning disks) with data accessed more frequently located on faster media (e.g., solid state disks). As the data categorized as cold data grows and ages, conventional systems leave the cold data alone until more disk space is needed and then additional storage space can be added which can be an expensive and time intensive process.

In conventional systems, a warning message may be issued to a host system when the storage space is at a particular warning level or completely exhausted. Once the storage space is completely exhausted, volumes in the storage become write inhibited.

By enabling the automatic migration of data to cloud storage when local storage space reaches a threshold, embodiments described herein may prevent data volumes from becoming write inhibited due to exhausting available storage space, as described in more detail below. In particular, cold data and/or data that has been previously identified as being transferable to the cloud may be transferred to one or more cloud based ranks to free additional local storage space. The amount and/or rate of data transferred may be dependent on the severity of the low space condition. The severity of the low space condition may be determined by threshold values of space.

To access a storage control unit 110, a host system 106 may communicate over physical connections from one or more ports on the host 106 to one or more ports on the storage control unit 110. A connection may be through a switch, fabric, direct connection, or the like. In certain embodiments, the hosts 106 and storage control units 110 may communicate using a networking standard such as Fibre Channel (FC) or iSCSI.

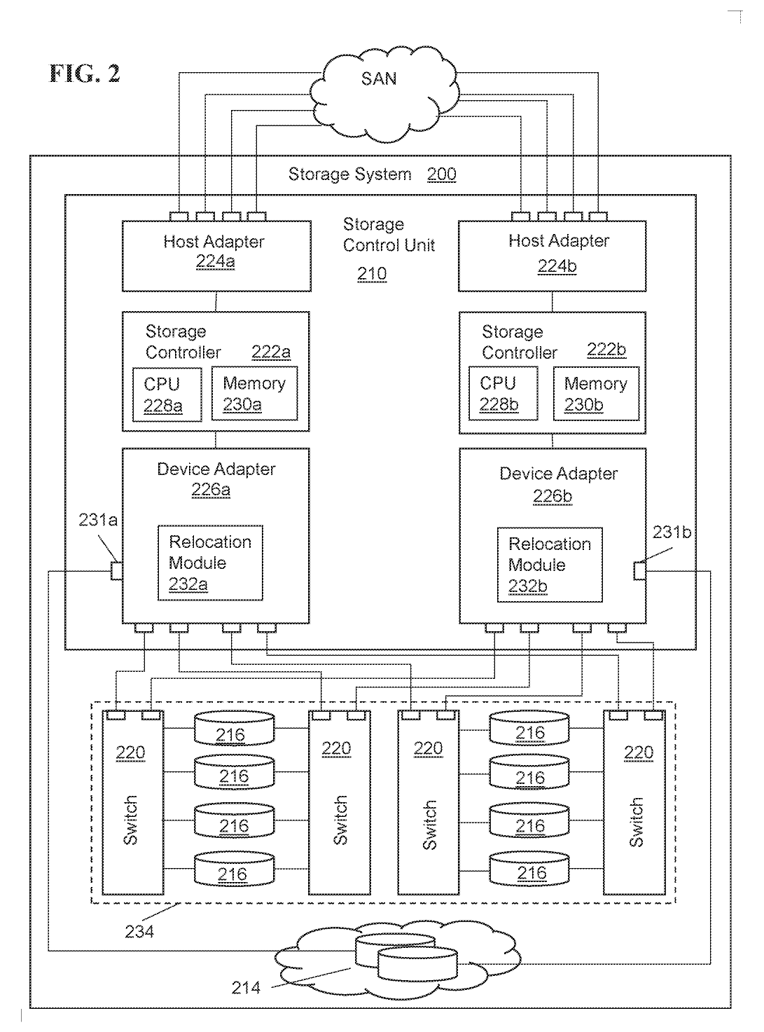

FIG. 2 is a high-level block diagram of one embodiment of a storage system 200. Storage system 200 includes one or more arrays of storage drives (e.g., hard-disk drives and/or solid-state drives). As shown, the storage system 200 includes a storage control unit 210, a plurality of switches 202, and a plurality of storage drives 216 such as hard disk drives and/or solid-state drives (such as flash-memory-based drives). The storage control unit 210 may enable one or more hosts (e.g., open system and/or mainframe servers) to access data in the plurality of storage drives 216.

In some embodiments, the storage control unit 210 includes one or more storage controllers 222. In the example shown in FIG. 2, the storage control unit includes storage controller 222a and storage controller 222b. Although only two storage controllers 222 are shown herein for purposes of explanation, it is to be understood that more than two storage controllers can be used in other embodiments. The storage control unit 210 in FIG. 2 also includes host adapters 224a, 224b (collectively 224) and device adapters 226a, 226b (collectively 226) to connect the storage control unit 210 to host devices and storage drives 204, respectively. Multiple storage controllers 222a, 222b (collectively 222) provide redundancy to help ensure that data is available to connected hosts. Thus, when one storage controller (e.g., storage controller 222a) fails, the other storage controller (e.g., 222b) can pick up the I/O load of the failed storage controller to ensure that I/O is able to continue between the hosts and the storage drives 204. This process can be referred to as a “failover.”

Each storage controller 222 can include respective one or more processors 228a, 228b (collectively 228) and memory 230a, 230b (collectively 230). The memory 230 can include volatile memory (e.g., RAM) as well as non-volatile memory (e.g., ROM, EPROM, EEPROM, flash memory, etc.). The volatile and non-volatile memory can store software modules that run on the processor(s) 228 and are used to access data in the storage drives 204. The storage controllers 222 can host at least one instance of these software modules. These software modules can manage all read and write requests to logical volumes in the storage drives 204.

In particular, each storage controller 222 is communicatively coupled to the storage drives 204 via a respective device adapter 226. Each device adapter 226 is configured to manage Input/Output (I/O) accesses (also referred to herein as data access requests or access requests) to the storage drives 216. For example, the device adapters 226 logically organize the storage drives 216 and determine where to store data on the storage drives 216. The storage drives 216 (also referred to as disk drive modules (DDM)) can include groups of different types of drives having different performance characteristics. For example, the storage drives 216 can include a combination of (relatively) slow 'nearline' disks (e.g., 7,200 revolutions per minute (RPM) rotational speed), SAS disk drives (e.g., 10k or 15k RPM) and relatively fast solid state drives (SSD).

The device adapters 226 are coupled to the storage drives 216 via switches 220. Each of the switches 220 can be fiber switches coupling the storage drives 216 to the device adapters via fiber optic connections. The device adapters 226 logically group the storage drives 216 into array sites 234. For purposes of illustration, a single array site 234 comprised of storage drives 216 is depicted in FIG. 2. However, it is to be understood that more than one array site comprised of storage drives 216 can be included in other embodiments. The array site 234 can be formatted as a Redundant Array of Independent Disks (RAID) array 234. It is to be understood that any type of RAID array (e.g., RAID 0, RAID 5, RAID 10, etc.) can be used. Each RAID array is also referred to as a rank. Each rank is divided into a number of equally sized partitions referred to as extents. The size of each extent can vary based on the implementation. For example, the size of each extent can depend, at least in part, on the extent storage type. The extent storage type (e.g., Fixed Block (FB) or count key data (CKD)) is dependent on the type of host coupled to the storage control unit (e.g., open-systems host or mainframe server). The extents are then grouped to make up logical volumes.

The storage control unit 210 can enable various management features and functions, such as, but not limited to, full disk encryption, non-volatile storage (NVS) algorithms (e.g., thresholding, stage, destage), storage pool striping (rotate extents), dynamic volume expansion, dynamic data relocation, intelligent write caching, and adaptive multi-stream prefetching. One example of a storage control unit 210 having an architecture similar to that illustrated in FIG. 2 is the IBM DS8000™ series enterprise storage system. The DS8000™ is a high-performance, high-capacity storage control unit providing disk and solid-state storage that is designed to support continuous operations. Nevertheless, the embodiments disclosed herein are not limited to the IBM DS8000™ series enterprise storage system, but can be implemented in any comparable or analogous storage system or group of storage systems, regardless of the manufacturer, product name, or components or component names associated with the system. Thus, the IBM DS8000™ is presented only by way of example and is not intended to be limiting.

Additionally, in the embodiment shown in FIG. 2, each of the device adapters 226 includes a respective network port 231a, 231b, such as an Ethernet port, which communicatively couples the device adapter 226 to cloud storage devices 214 via a network, such as the internet. In the example shown in FIG. 2, each device adapter 226 further includes a respective relocation module 232a, 232b (collectively 232) which is configured to allocate and group cloud storage devices 214 into virtual RAID arrays, such that the cloud storage devices 214 appear to the storage controllers 222 as a local RAID array or rank. In this way, the features and functions of the storage controllers 222 that are available for local ranks, such as RAID array 234, are also available for the cloud rank.

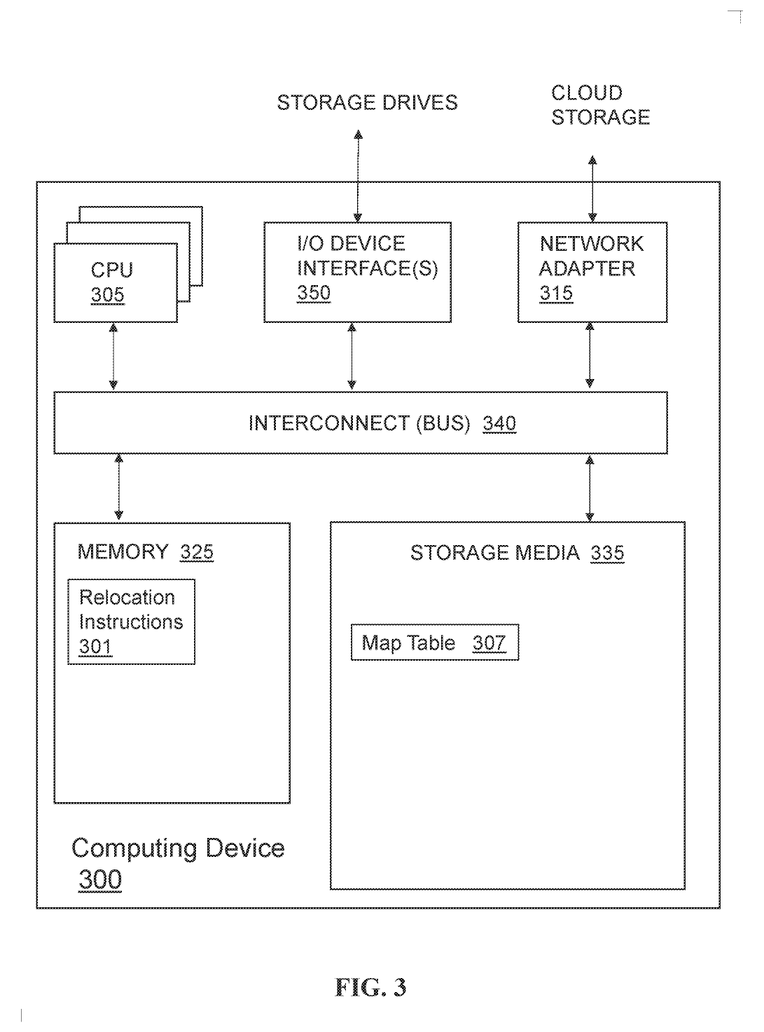

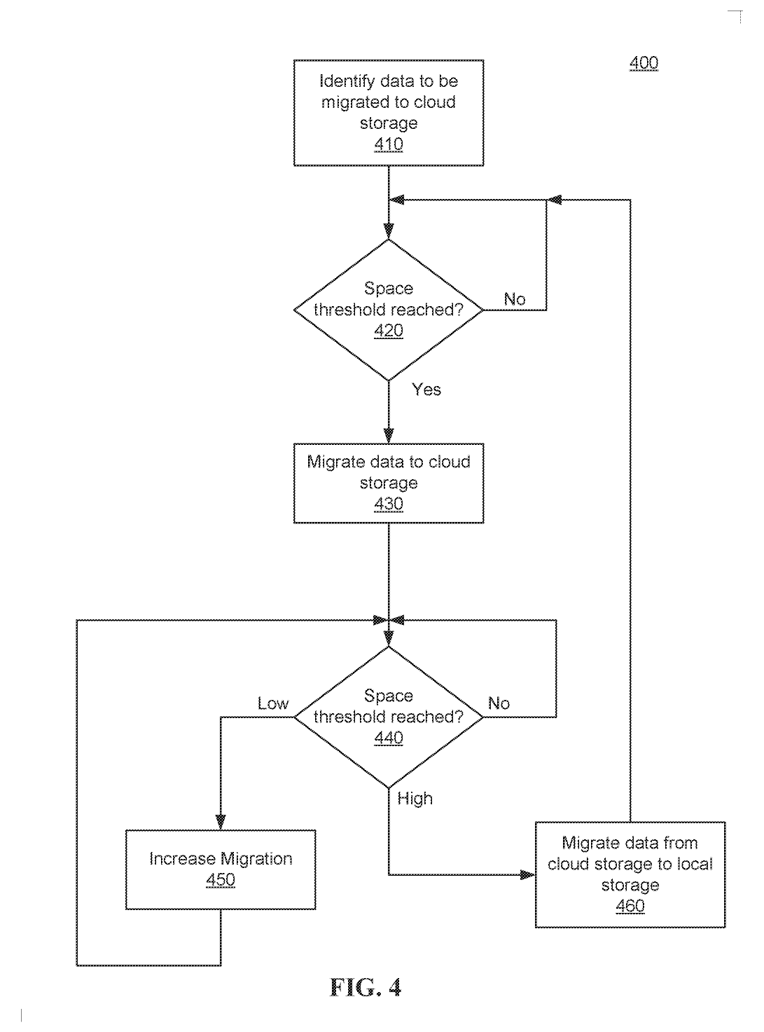

As described in more detail below with respect to FIGS. 3 and 4, the relocation module 232 is configured to convert between storage controller commands and/or I/O accesses and cloud interface commands and/or I/O accesses. It is to be noted that although a relocation module 232 is included in the device adapters 226 in this example, the relocation module 232 can be included in storage controllers 222 in other embodiments. In particular, in some embodiments, each storage controller 222 includes a respective relocation module that does the conversion for commands to the respective device adapter 226.

Thus, the embodiments described herein enable advantages over conventional cloud storage systems. For example, conventional cloud storage systems typically enable relatively basic functionality, such as remote archiving, backup, and retrieval. However, such conventional systems are unable to perform advanced management functions on the data stored in the cloud, such as the management functions mentioned above (e.g., NVS algorithms such as thresholding, stage, and destage). Thus, through the use of the relocation module 232, discussed in more detail below, the embodiments described herein enable the performance of advanced management features on data stored on cloud storage devices which is not available for conventional cloud storage systems. In particular, through the use of the relocation module 232, the storage controllers 222 and device adapters 226 are able to access and utilize the virtual RAID arrays or ranks comprised of cloud storage as if the virtual RAID arrays were local drives coupled to the device adapters 226 rather than as remote storage. In this way, the same management features/functionality available for local drives, such as those mentioned above, are available for the remote cloud storage without modifying the underlying code and/or hardware associated with implementing those management features.

Furthermore, by creating virtual RAID arrays that appear as local storage to the storage control unit 210, the embodiments described herein provide a solution to a problem of exhausting storage space. In particular, the relocation module 232 may be configured to monitor data accesses to data on the plurality of storage devices of one or more RAID arrays (e.g., array 234) in the storage system. Based on the monitored accesses, the relocation module 232 can identify a plurality of categories of data. For example, in some embodiments, the relocation module 232 identifies a hot data category and a cold data category. The hot data category may correspond to data which has data accesses within a first time period. The cold data category may correspond to data which has not had a data access within the first time period. As described in more detail below, the relocation module 232 may be configured to move data in the cold category to one or more of the cloud based ranks based on available local storage space reaching a threshold level.

FIG. 3 is a block diagram of an embodiment of an example computing device 300 which can be implemented as a device adapter, such as device adapters 226 or a storage controller, such as storage controllers 222. For purposes of explanation, computing device 300 is described herein with respect to a device adapter. In the example shown in FIG. 3, the device adapter 300 includes a memory 325, storage 335, an interconnect (e.g., BUS) 340, one or more processors 305 (also referred to as CPU 305 herein), an I/O device interface 350, and a network adapter or port 315.

Each CPU 305 retrieves and executes programming instructions stored in the memory 325 and/or storage 335. The interconnect 340 is used to move data, such as programming instructions, between the CPU 305, I/O device interface 350, storage 335, network adapter 315, and memory 325. The interconnect 340 can be implemented using one or more busses. The CPUs 305 can be a single CPU, multiple CPUs, or a single CPU having multiple processing cores in various embodiments. In some embodiments, a processor 305 can be a digital signal processor (DSP). Memory 325 is generally included to be representative of a random access memory (e.g., static random access memory (SRAM), dynamic random access memory (DRAM), or Flash). The storage 335 is generally included to be representative of a non-volatile memory, such as a hard disk drive, solid state device (SSD), removable memory cards, optical storage, or flash memory devices.

In some embodiments, the memory 325 stores relocation instructions 301 and the storage 335 stores map table 307. However, in various embodiments, the relocation instructions 301 and the map table 307 are stored partially in memory 325 and partially in storage 335, or they are stored entirely in memory 325 or entirely in storage 335.

When executed by the CPU 305, the relocation instructions 301 cause the CPU 305 to utilize the map table 307 to implement the relocation module discussed above with respect to FIG. 2. It is to be noted that although the relocation instructions 301 and map table 307 are depicted as being stored in and executed/utilized by a device adapter 300, in other embodiments the relocation instructions 301 and map table 307 can be stored on and executed/utilized by a storage controller such as storage controller 222a and/or storage controller 222b shown in FIG. 2. The relocation instructions 301 cause the CPU 305 to allocate space on cloud storage devices, such as cloud storage devices 214 depicted in FIG. 2. The space can be allocated statically or on demand as need arises. For example, the space can be allocated a priori or at run time. Furthermore, the cloud storage ranks can be created with different storage capacity.

The relocation instructions 301 further cause the CPU 305 to group the allocated storage into one or more virtual ranks and to store a mapping between the cloud storage devices and the one or more virtual ranks in the map table 307. In particular, the relocation instructions 301 cause the CPU 305 to generate the map table 307 which maps the allocated storage space to corresponding virtual local addresses and groups the virtual local addresses to create one or more virtual local ranks or RAID arrays. In this way, the virtual ranks of cloud storage appear as local direct attached ranks to a storage controller communicatively coupled to the device adapter 300 via the I/O device interfaces 350. The I/O device interfaces 350 also communicatively couple the device adapter 300 to local ranks of storage devices, such as solid state drives and nearline drives (e.g., storage drives 216 discussed above). For example, the I/O device interfaces 350 can include fiber optic ports. As used herein, a local rank is a rank or RAID array comprised of storage devices that are directly connected to the device adapter 300 without an intervening wide area network, such as the internet.

When an I/O access (e.g., a read or write request) is received, the cloud conversion instructions 301 cause the CPU 305 to determine if the request is directed to data stored on a virtual rank of cloud storage. When the request is directed to data stored on a virtual rank of cloud storage, the relocation instructions 301 convert the I/O access (also referred to herein as a data access request or access request) for transmission to the cloud storage device via a cloud interface. For example, the relocation instructions 301 can convert the I/O access using commands, format, device address, etc. used by the cloud interface to access the cloud storage devices. As used herein, the terms I/O access, read/write access, and data access can be used interchangeably. Exemplary cloud interfaces can include, but are not limited to, the IBM® Cloud Manager or the Amazon® Simple Storage Service (Amazon S3) interface. Thus, as discussed above, the relocation instructions 301 transparently makes cloud storage available to a storage controller similar to other local storage devices.

In addition, the relocation instructions 301 may cause the CPU 305 to automatically migrate data to the cloud storage when local storage space reaches a threshold to prevent data volumes from becoming write inhibited due to exhausting available storage space. In particular, the relocation instructions 301 may cause the CPU 305 to automatically migrate cold data and/or data that has been previously identified as being transferable to cloud based. For example, the relocation instructions 301 can be configured to cause the CPU 305 to perform the automatic migration to cloud described in more detail with respect to FIG. 4.

In addition, the relocation instructions 303 are configured, in some embodiments to cause the CPU 305 to assign a service level to the cloud based ranks. In some such embodiments, there are three levels of service. However, in other embodiments providing multiple levels of service, two or more than 3 levels of service can be provided. In this example, three levels of service are utilized and the selection of the level of service is based on the compressibility of the data being mirrored, a respective input/output data rate for the virtual local ranks, and a service level agreement. For example, if a service level agreement indicates a low quality of service, the I/O data rate for the virtual local rank is below a threshold, and the data being accessed is compressible, then a first level of service is selected. A low quality of service can be any quality of service below a pre-defined threshold level of service. The first level of service is the lowest level of service from the three options in this example. For example, it can include higher latencies and lower throughput than the other two levels of service. If the service level agreement indicates a low quality of service, the I/O data rate for the virtual local rank is below a threshold, and the data is not compressible, then the second level of service is selected. The second level of service has greater throughput and/or less latency than the first level of service. The last or third level of service is used for all other data (e.g., the SLA indicates a level of service above the pre-defined threshold and/or the I/O data rate is above a threshold). The third level of service has greater throughput and/or less latency than both the first and second levels of service.

By providing differing levels of service, the device adapter 326 is able to leverage the virtual ranks of cloud storage to provide greater flexibility in meeting the customer needs for data storage and access. It is to be noted that although the example first, second, and third levels are described as differing in latency and throughput, other factors can be used to differentiate the levels of service. For example, in some embodiments, the three levels of service have the same latency and throughput, but differ in cost and redundancy level.

FIG. 4 is a flow chart depicting an embodiment of a method 400 for automatic migration of data to cloud storage. Method 400 is described herein as being implemented by a storage control unit, such as storage control unit 110 or storage control unit 210. Method 400 can be implemented by a device adapter, such as device adapters 226, or a storage controller, such as storage controllers 222. For example, method 400 can be implemented by a CPU, such as CPU 305 in computing device 300, executing instructions, such as relocation instructions 301. It is to be understood that the order of actions in example method 400 is provided for purposes of explanation and that the method can be performed in a different order in other embodiments. Similarly, it is to be understood that some actions can be omitted or additional actions can be included in other embodiments.

At operation 410, data to be migrated to cloud storage is identified. Data to be migrated to cloud may be identified by the storage control unit in various ways. In some embodiments, data to be migrated to cloud storage may be identified by a host system. For example, the host system may identify volumes that can be migrated to cloud storage. The host system may do this when the volume is created or may do this following a write, indicating that the host may not access the volume again. When the storage control unit receives an indication from the host system that a volume can be migrated to cloud storage, the storage control unit may add the volume to a list of data that can be migrated to cloud storage.

In some embodiments, certain types of data volumes may be predetermined as a volume that can be migrated to cloud storage. The host may be preconfigured to include an indication that a volume can be migrated to cloud when a certain type of volume is created by the host. For example, a volume that is intended as a point-in-time copy (such as a Safeguarded Copy in the IBM DS8000™) may be automatically identified as a volume that can be migrated to cloud storage.

In some embodiments, the storage control unit may identify data to be migrated to cloud storage based on read/write activity over a period of time (e.g., weeks/months). Data volumes that have had no or minimal read/write activity in the period of time may be identified as data to be migrated to the cloud. For example, volumes identified by the storage control unit as cold data may be identified as data to be migrated to cloud storage. Further, the volumes may be ranked based on read/write activity and identified for migration to cloud storage based on the ranking. The ranking may be maintained within a memory of the storage control unit. In some embodiments, only volumes that are classified as cold data may be included in the ranking and/or identified as data that can be migrated to cloud storage.

At operation 420, it may be determined whether a local storage space threshold has been reached. A threshold may be used to determine when the storage control unit is running out of local storage space. The storage control unit may monitor the available local storage space to determine whether the threshold has been reached. If the threshold has not been reached, the storage control unit may repeat operation 420 until the threshold is reached. The threshold may be based on any suitable measure of the available local storage space, such as the total local storage space available, the percentage of total local storage that is available space, the percentage of total local storage that has been used, or any other indicator of the available local storage space. For example, if the threshold value is 10% of the total local storage is available space, the threshold may be reached when the available local storage is 10% of the total local storage or less. As another example, if the threshold value is 90% of the total local storage is used, then the threshold may be reached when the total local storage used is 90% or above.

In response to the local storage space threshold being reached, at operation 430, data may be migrated from local storage to cloud storage. The storage control unit may select the data to be migrated based on the data identified in operation 410. Migrating the data may include transferring the data to the cloud and releasing the corresponding space on the local storage. The data transferred may include all of the data identified in operation 410. For example, all data previously identified by a host system as data to be migrated to cloud storage and/or data classified as cold data may be migrated to cloud storage. Alternatively, some subset of the data identified in operation 410 may be transferred to cloud storage, such as a predetermined amount of data or a percentage of the total data. The selection of data to be migrated may be prioritized based on the identification in operation 410. For example, data identified by a host for migration to cloud storage may be selected over data selected based on read/write activity. Further, the ranking of data based on read/write activity may be used as the order for selecting data to migrate to cloud storage.

When a read for data that has been migrated to cloud occurs, the storage control unit may read the cloud storage into the storage control unit cache. If the data is in the process of migration, the storage control unit may check if the track being read still exists on the local storage and, if so, read from the local storage.

When a write for data that has been migrated to cloud storage occurs, the storage control unit may destage the storage control unit cache into cloud storage. If the data is in the process of migration, then the storage control unit may check if the track being written still exists on the local storage and, if so, will sync destage the track onto the local storage.

At operation 440, the local storage space may be monitored for reaching another threshold. As depicted in FIG. 4, there may be a low threshold and a high threshold. The low threshold may be set to indicate that there is a low amount of local storage space available. This low threshold may be set at a value that indicates less available space than the threshold in operation 420. For example, the threshold in operation 420 may be 10% of local storage is available space and the low threshold in operation 440 may be 5% of local storage is available. Reaching the low threshold may indicate that more data needs to be migrated to cloud storage or that the rate of migrating data to cloud storage needs to be increased to keep up with the rate of writes to local storage.

At operation 450, the data migration may be increased. If the storage control unit is already in the process of migrating data, the rate of data migration may be increased. This may allow for the rate of data migration to surpass the rate of new writes to the local storage. Alternatively, if there is not currently any data being migrated to cloud storage, the storage control unit may migrate additional data to cloud storage. This may include migrating data that was identified in operation 410 that has not already been migrated. In some embodiments, the storage control unit may migrate data from a different classification of data than was migrated in operation 430. For example, if the storage control unit classifies data into 3 classifications based on data access (e.g., hot, cold, extremely cold) and the storage control unit migrated all of the data corresponding to one classification (e.g., extremely cold) to cloud storage, the storage control unit may then migrate data corresponding to a second classification (e.g., cold). The storage control unit may be configured such that data with certain classifications (e.g., hot) are not transferred to cloud storage. After operation 450, the storage control unit may return to operation 440 to monitor available storage space for reaching another threshold.

Referring to operation 440, the storage control unit may further identify a high threshold in the local storage space. The high threshold may be set to indicate that there is sufficient space available on the local storage, such that data that has been migrated to cloud storage can be migrated back to local storage. For example, if the threshold for migrating data to cloud storage in operation 420 is 10% of local storage is available space, the high threshold for migrating data from cloud storage to local storage may be 50% of local storage is available space.

In response to the storage control unit determining that a high local space threshold has been reached, the storage control unit may migrate data from the cloud storage to the local storage at operation 460. In some embodiments, there may be certain data that is not migrated back to local storage even when the high threshold has been reached. For example, certain types of data (e.g., point-in-time copies) or data with certain classifications (e.g., extremely cold) may not be migrated from cloud storage to local storage.

As stated above, the order of actions in example method 400 is provided for purposes of explanation and method 400 can be performed in a different order and/or some actions can be omitted, or additional actions can be included in other embodiments. Similarly, it is to be understood that some actions can be omitted, or additional actions can be included in other embodiments. For example, in some embodiments, operation 410 may be done after operation 420. Additionally, it is to be understood that acts do not need to be performed serially. For example, the identifying described operation 410 can occur at the same time or overlap with the other acts described in method 400.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the inventive methods, such as automatic migration to cloud module 600. In addition to block 600, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 600, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

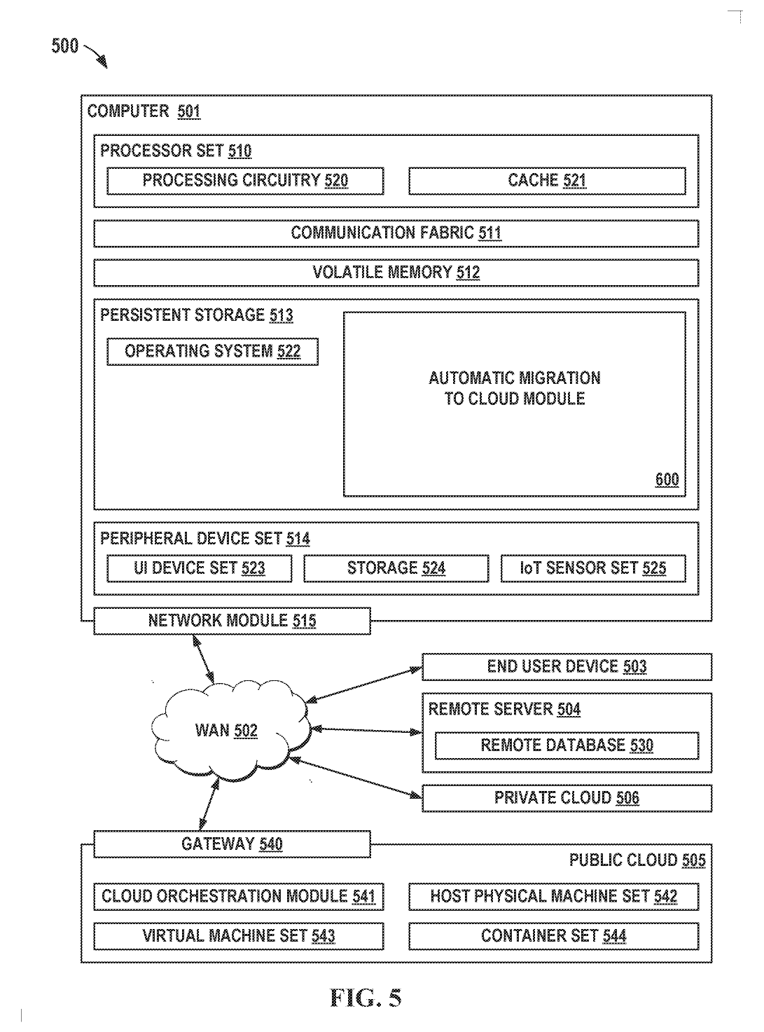

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer-readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 600 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 600 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer-readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

CLOUD COMPUTING SERVICES AND/OR MICROSERVICES (not separately shown in FIG. 5): private and public clouds 506 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A method migrating data to cloud storage, the method comprising:
identifying, by a storage control unit, data to be migrated to cloud storage;
determining, by the storage control unit, that local storage space has reached a threshold; and
in response to determining that the local storage space has reached the threshold, migrating, by the storage control unit, data from local storage to cloud storage.

2. The method of claim 1, wherein the identifying data to be migrated to cloud storage comprises determining data pre-identified for cloud storage migration by one or more hosts.

3. The method of claim 1, wherein the identifying data to be migrated to cloud storage is based on read/write activity.

4. The method of claim 1, further comprising ranking a plurality of volumes based on read/write activity, wherein identifying the data to be migrated is based on the ranking.

5. The method of claim 1, wherein the identifying data to be migrated to cloud storage comprises identifying data based on a ranked list, wherein the ranked list is based on read/write activity.

6. The method of claim 1, further comprising:
determining, by the storage control unit, that available storage space is above a second threshold; and
in response to determining that available storage space is above the second threshold, migrating data from cloud storage to local storage.

7. The method of claim 1, further comprising:
determining that storage space is below a second threshold; and
in response to determining that the storage space is below the second threshold, increasing a rate of the migrating the data from local storage to cloud storage.

8. The method of claim 1, wherein the local data is assigned to a plurality of classifications based on read/write activity and wherein the identifying the data comprises identifying data in a classification associated with low read/write activity.

9. A computer program product comprising a computer-readable storage medium having program instructions embodied therewith, the program instructions executable by one or more processors to cause the one or more processors to perform operations comprising:
identifying, by a storage control unit, data to be migrated to cloud storage;
determining, by the storage control unit, that local storage space has reached a threshold; and
in response to determining that the local storage space has reached the threshold, migrating, by the storage control unit, data from local storage to cloud storage.

10. The computer program product of claim 9, wherein the identifying data to be migrated to cloud storage comprises determining data pre-identified for cloud storage migration by one or more hosts.

11. The computer program product of claim 9, wherein the identifying data to be migrated to cloud storage is based on read/write activity.

12. The computer program product of claim 9, wherein the operations further comprise ranking a plurality of volumes based on read/write activity, wherein identifying the data to be migrated is based on the ranking.

13. The computer program product of claim 9, wherein the identifying data to be migrated to cloud storage comprises identifying data based on a ranked list, wherein the ranked list is based on read/write activity.

14. The computer program product of claim 9, wherein the operations further comprise:
determining, by the storage control unit, that available storage space is above a second threshold; and
in response to determining that available storage space is above the second threshold, migrating data from cloud storage to local storage.

15. The computer program product of claim 9, wherein the operations further comprise:
determining that storage space is below a second threshold; and
in response to determining that the storage space is below the second threshold, increasing a rate of the migrating the data from local storage to cloud storage.

16. The computer program product of claim 9, wherein the local data is assigned to a plurality of classifications based on read/write activity and wherein the identifying the data comprises identifying data in a classification associated with low read/write activity.

17. A system comprising, a storage control unit having one or more processors communicatively coupled to one or more memories, the one or more processors configured to perform operations comprising:
identifying data to be migrated to cloud storage;
determining that local storage space has reached a threshold; and
in response to determining that the local storage space has reached the threshold, migrating data from local storage to cloud storage.

18. The system of claim 17, wherein the identifying data to be migrated to cloud storage comprises determining data pre-identified for cloud storage migration by one or more hosts.

19. The system of claim 17, wherein the identifying data to be migrated to cloud storage is based on read/write activity.

20. The system of claim 17, wherein the operations further comprise ranking a plurality of volumes based on read/write activity, wherein identifying the data to be migrated is based on the ranking.
